(19) United States
(12) Patent Application Publication
(10) Pub. No.: US 2010/0128195 A1
(43) Pub. Date: May 27, 2010

(54) Backlight Module and Liquid Crystal Display Device Using the Same

(75) Inventors: Yueh-Han Li, Hsin-Chu (TW); Po-Tang Hsu, Hsin-Chu (TW); Chih-Fu Hsu, Hsin-Chu (TW); Chien-Ming Ko, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/619,875

(22) Filed: Nov. 17, 2009

(30) Foreign Application Priority Data
Nov. 21, 2008 (TW) 97145116

(51) Int. Cl. G02F 1/13357; G09F 13/04

(52) U.S. Cl. 349/58; 362/97.2

(57) ABSTRACT

The present invention is a backlight module including a housing, a reflective sheet, and a light source module. The housing has an inner side surface, an outer side surface, and a plurality of first openings. The reflective sheet is disposed on the inner side surface and has a plurality of second openings corresponding to the first openings. The light source module has a plurality of light sources, wherein the light source module is disposed on the outer side surface, and each of the light sources may penetrate each of the first openings and the second openings. When the light sources are dimmed or have other problems, the light source module can be taken apart from the housing to repair them easily.

This application claims priority based on a Taiwanese patent application No. 097145116 filed on Nov. 21, 2008, the disclosure of which is incorporated herein by reference in its entirety.

### BACKGROUND OF THE INVENTION

1. Field of the Invention

The present invention relates to a backlight module. Specifically, the present invention relates to a backlight module which can use light-emitting diodes and rework/repair easily.

2. Description of the Prior Art

Liquid crystal displays (LCDs) are not a self-emitting display device, thus, a backlight module is an essential component to most LCDs. Different backlight module techniques have a decisive impact on the ultimate product in terms of thickness, display quality, environmentally conscious design, power efficiency, product life span, price competitiveness, etc.

In the current market, cold cathode fluorescent lamps (CCFLs) are adopted as the backlight source for most LCD devices; however, the CCFLs only display around 70% to 80% of the NTSC (National Television Standards Committee) color gamut. Also, the CCFLs include mercury (Hg), which does not conform to the environmental protection standards of the European Union (EU). For a solution, industries look into the possibility of substituting light emitting diodes (LEDs) for the CCFLs as the backlight source. When using the LEDs as the backlight source, the LCD provides a wider color gamut and better color performance since the LED has characteristics such as delicacy, high brightness, no mercury, high color reproducibility, etc.

FIG. 1 and FIG. 2 show a conventional LCD display device using the LED as a backlight source. The backlight module 10 includes a casing 12, a light emitting diode module (LED module) 15, a reflective plate 18, and a plurality of optical films 20. The plurality of optical films 20, the reflective plate 18, and the LED module 15 are respectively assembled and covered inside the casing 12. A plurality of light emitting diodes (LEDs) 14 is disposed on the printed circuit board 16, and a plurality of holes 19 are formed on the reflective plate 18 corresponding to the LEDs 14, such that each of the holes 19 can penetrate each of the LEDs 14 and attach to the side surface of the LED module 15.

The LEDs 14 should be repaired while the displaying or emitting performance encounters problems such as local dimming, RGB dimming or other reasons, so that the backlight module 10 can provide normal chromaticity. In the reparation, the backlight module 10 must be disassembled element by element to finally take out the LED module 15 from the casing 12. The aforesaid disassembly process is quite inconvenient and time consuming, especially if the LED 14 only needs to be renewed or adjusted. Therefore, the present invention is provided to improve the aforesaid problems and achieve other objectives.

### SUMMARY OF THE INVENTION

It is an objective of the present invention to provide a backlight module and a display device using the same which can be easily reworked.

It is another objective of the present invention to provide a backlight module and a display device using the same which can be directly disposed on a heat dissipation or temperature uniformity element.

It is another objective of the present invention to provide a backlight module and a display device that increases light mixing distance.

It is another objective of the present invention to provide a backlight module and a display device using the same of a lighter weight.

The present invention provides a backlight module including a housing, a reflective sheet, and a light source module. The housing has an inner side surface, an outer side surface, and a plurality of first openings. The reflective sheet is disposed on the inner side surface and has a plurality of second openings corresponding to the first openings. The light source module has a plurality of light sources, wherein the light source module is disposed on the outer side surface, and each of the light sources may penetrate each of the first openings and the second openings.

In the preferred embodiment, the housing further has a back wall, and the inner side surface and the outer side surface respectively form two opposite sides of the back wall. Each of the light sources penetrates each of the first openings and the second openings, and a cross-section of each of the light sources along a direction parallel to the housing corresponds to a shape of each of the first openings. In addition, the light source is composed of a printed circuit board with the light sources disposed thereon. When the light source module is mounted on the casing, the printed circuit board is disposed outside the outer side surface of the housing, and an upper surface of the printed circuit board is not exposed in the first openings.

The present invention further provides a display device including a front frame and a backlight module. The backlight module is composed of structures of the abovementioned embodiment, which will not mention again.

### BRIEF DESCRIPTION OF THE DRAWINGS

FIG. 1 shows an exploded view of a conventional backlight module;

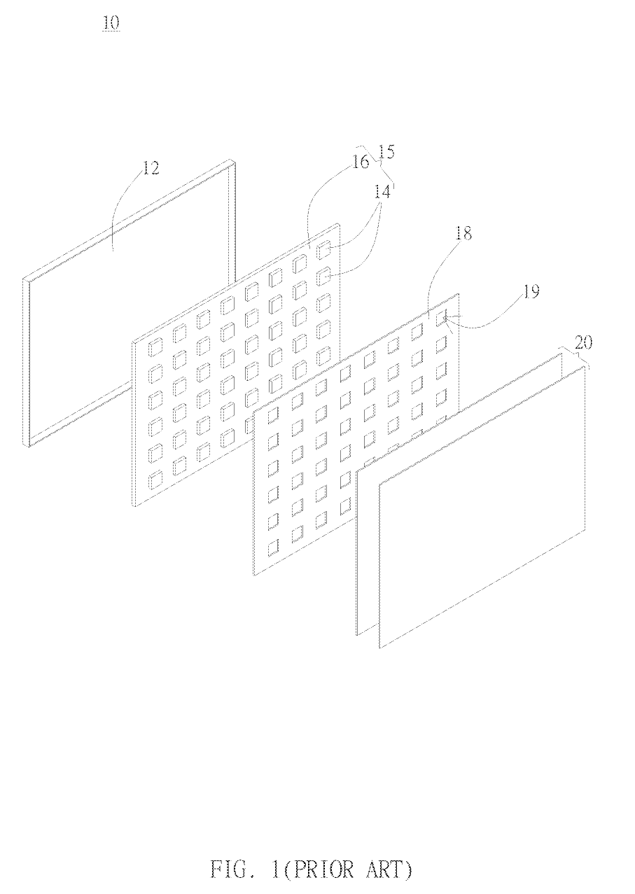

FIG. 2 illustrates a side view of FIG. 1;

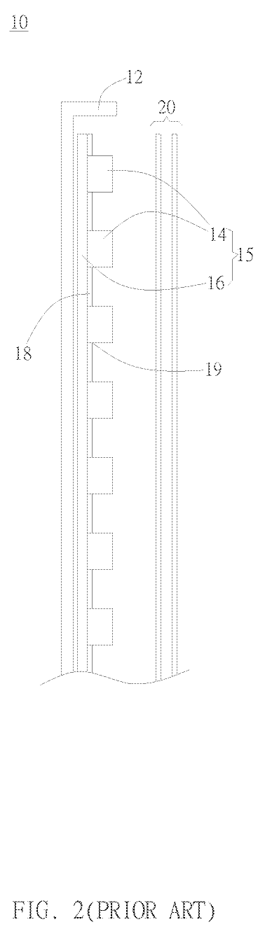

FIG. 3 illustrates an exploded view of a backlight module of the present invention;

FIG. 4A illustrates a side view of FIG. 3;

FIG. 4B illustrates another side view of FIG. 3;

FIG. 5A illustrates a schematic view of the backlight module disposed on a heat dissipation unit according to the present invention;

FIG. 5B illustrates another schematic view of the backlight module disposed on the heat dissipation unit according to the present invention;

FIG. 6 illustrates an exploded view of a display device according to the present invention; and

FIG. 7 illustrates a side view of the display device according to the present invention.

### DETAILED DESCRIPTION OF THE PREFERRED EMBODIMENT

The present invention is a backlight module and a display module using the same, which includes a housing with a plurality of openings such that a plurality of light sources of a light source module can correspond to the openings and be assembled to the housing from outside the housing. In a preferred embodiment, the light source module includes a light emitting diode module (LED module), i.e., the light source includes light emitting diode light sources (LED light sources). The LED light sources can be disposed on the LED module by way of individual LED or modular LED, such as LED light bar or other LED modules. Moreover, the backlight module of the present invention is preferably used in liquid crystal display panels (LCD panels), and preferably applied to large sized LCD panel devices. In other embodiments, however, the backlight module may also apply to traffic signals, car lamps, board of advertisements, or other devices as appropriate.

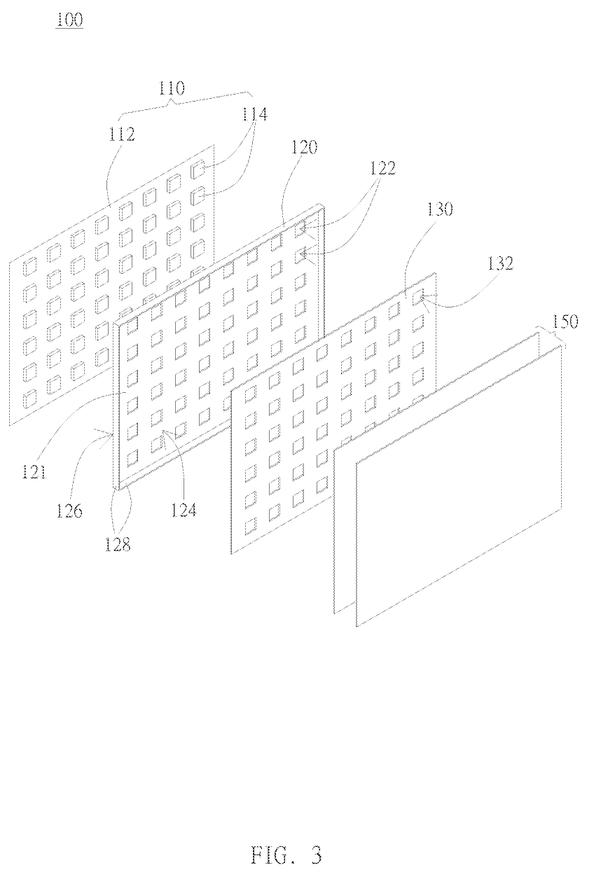

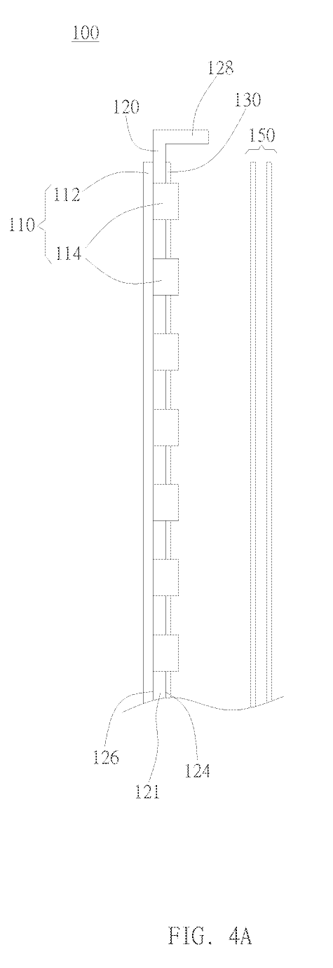

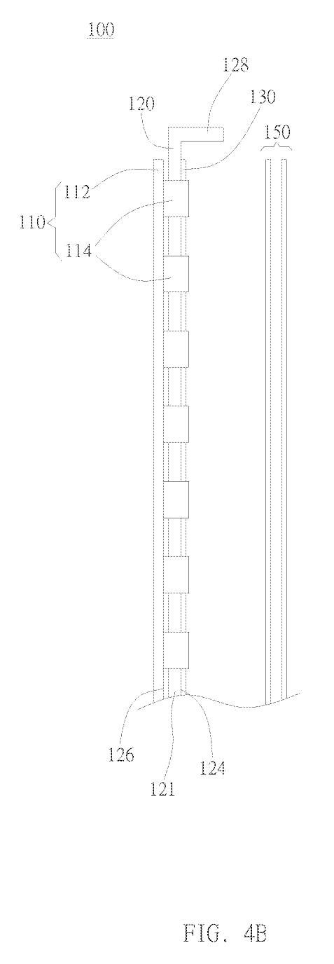

FIG. 3 and FIG. 4A illustrate an exploded view and a side view of the backlight module according to the present invention. The backlight module 100 includes a housing 120, a reflective sheet 130, a light source module 110, and a plurality of optical films 150. The housing 120 has an inner side surface 124, an outer side surface 126, and a plurality of first openings 122. In the embodiment shown in FIG. 3, the housing 120 further has a back wall 121, and the inner side surface 124 and the outer side surface 126 respectively form two opposite sides of the back wall 121. The housing 120 further has a side casing 128 on the perimeter of the back wall 121 and perpendicular to the inner side surface 124 for covering the optical films 150 or other elements as appropriate. The optical films 150 mentioned here disposed parallel to the reflective sheet and include a diffusion plate, a prism sheet or a brightness enhancement film, etc. to provide such concentration or uniformity of light characteristics. The reflection sheet 130 has a plurality of second openings 132 corresponding to the first openings 122. In other words, the cross-sectional shape of the first openings 122 is similar to that of the second openings 132. The reflective plate 130 is disposed on the inner side surface 124 to increase the usability of light by reflection of light.

In the present embodiment, the reflective sheet 130 such as polycarbonate sheet is preferably attached to the inner side surface 124 of the housing 120 by glue or other proper fasten methods. Therefore, when relative movement generates between the housing 120 and the light source module 110 such as during disassembly or assembly, the reflective sheet 130 will not interfere the movement of the light source module 110. Accordingly, such design will increase the convenience during rework or repair. Furthermore, since the housing 120 is provided with a lot of the first openings 122, the overall weight of the backlight module 100 will be lightened.

FIG. 3 shows that the light source module 110 has a plurality of light sources 114. The abovementioned light sources 114 are light emitting diode (LED) light sources and preferably arranged or composed of a LED light bar or LED module. The light source module 110 is disposed on the outer side surface 126 of the housing 120 in such a way that each of the light sources 114 penetrates each of the first openings 122 and the second openings 132 to protrude out of the inner side surface 124 of the housing 120. The light source module 110 is composed of a printed circuit board 112 and the light sources 114, and each of the light sources 114 is mounted and distributed on the printed circuit board 112. As FIG. 4A shows, when the light source module 110 is assembled from the outer side surface 126 of the housing 120 to the housing 120, the printed circuit board 112 preferably contacts with the outer side surface 126 of the housing 120, i.e., the printed circuit board 112 is disposed outside the outer side surface 126 of the housing 120. An upper surface of the printed circuit board 112 that closed to the housing is preferably not exposed in the first openings 122. Each of the light sources 114 penetrates each of the first openings 122 and second openings 132, and a cross-section of each of the light sources 114 along a direction parallel to the housing 120 corresponds to a shape of each of the first openings 122 and the second openings 132. In the embodiment shown in FIG. 4B, however, when the light source module 110 is assembled from the outer side surface 126 of the housing 120 to the housing 120, the printed circuit board 112 may maintain a distance with the outer side surface 126 of the housing 120 to increase the heat dissipation rate.

In this embodiment, the shape of each of the light sources 114 is preferably rectangular. In other embodiments, however, the shape of each of the light sources 114 may include circular, elliptical, triangular, or other irregular shapes. In other words, the shape of each of the first openings 122 and second openings 132 can change according to the cross-section shape of the light sources 114. In addition, in the embodiment, by disposing the light source module 110 on the outer side surface 126 of the housing 120 can also increase the light mixing distance of the LED light sources 114, such that the backlight module 100 is capable of enriching the colors of the flat liquid crystal panel device (LCD device).

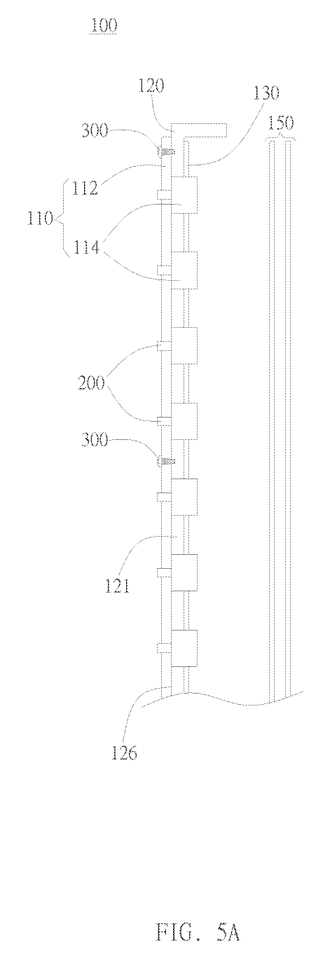

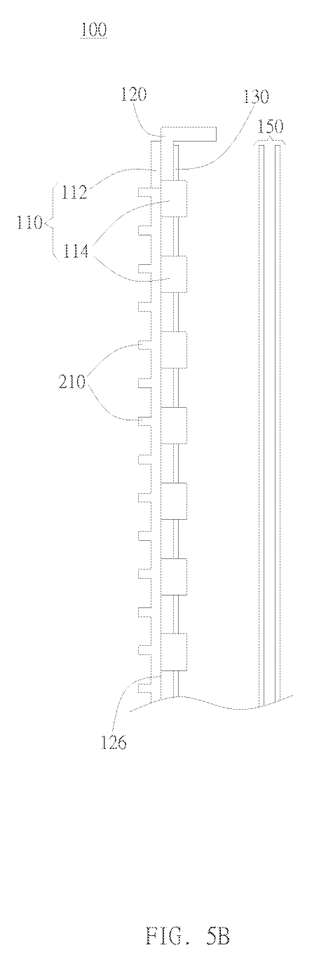

FIG. 5A illustrates an embodiment of the present invention which is provided with a heat dissipation unit. The present embodiment still has another advantage. Since the light source module 110 is disposed on the outer side surface 126 of the housing 120 directly, the light source module 110 provides a larger space for the heat dissipation unit 200 (or temperature uniformity element) to be disposed thereon to solve the problems of the heat effect generated by light sources 114 and indirectly affected brilliance, chromaticity, etc. As shown in FIG. 5A, holes are formed behind each of the light sources 114 of the light source module 110 for the heat dissipation unit 200 such as a heat sink, a radiating tube, a heat pipe, a heat dissipation post, or other heat dissipation elements to be inserted therein. In the embodiment shown in FIG. 5B, however, the light source module 110 may also dispose the heat sinks 210 on the bottom end of each of the light sources 114, such that the heat may be dissipated outside the outer side surface 126 of the housing 120 by the heat sinks 210 which contact with the light sources 114. In other embodiments, a fan can be disposed on the proper location of the light source module 110 to bring heat out of the outer side surface 126 of the housing 120 quickly after the heat is dissipated by the heat dissipation unit 200.

In addition, as shown in FIG. 5A, the light source module 110 is preferably disposed on the back wall 121 of the housing 120 by screws 300. In the embodiment shown in FIG. 5B, however, the light source module 110 may be mounted on the outer side surface 126 of the housing 120 by methods of being engaged, adhered, or pasted. When the light sources 114 become local dimming or otherwise need to be reworked/repaired, the disassembly only requires taking away the screws 300 or other relative elements and detaching the light source module 110 after taken apart from the housing 120 and the reflective sheet 130. Similarly, when the light source module 110 is assembled to the outer side surface 126 of the housing 120, each light source 114 penetrates each corresponding first opening 122 and second opening 132 and then fixed by the screws 300 or other relative elements to accomplish the rework/repair easily.

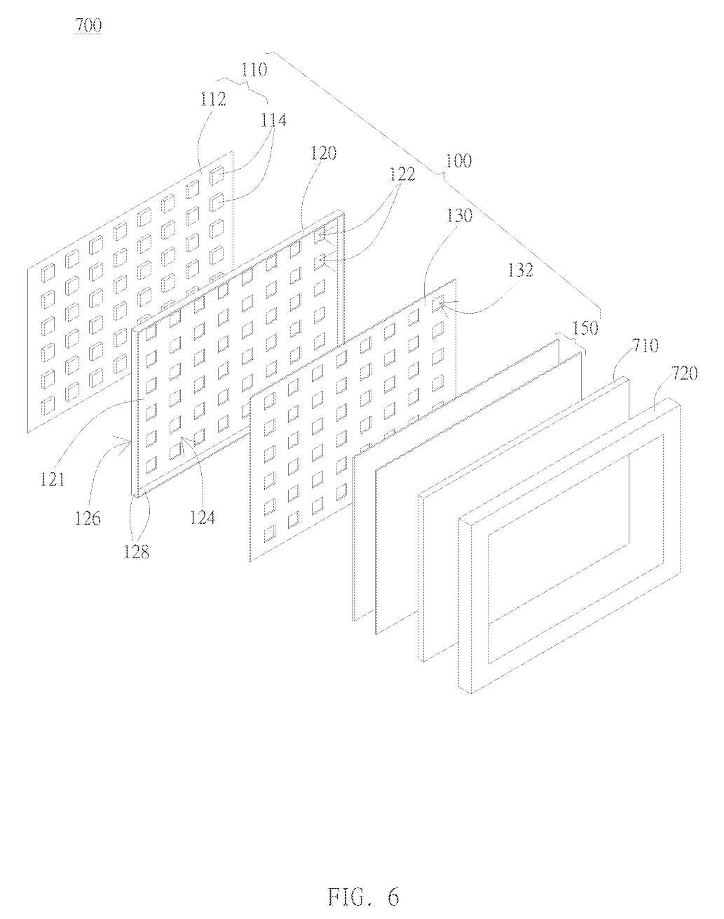

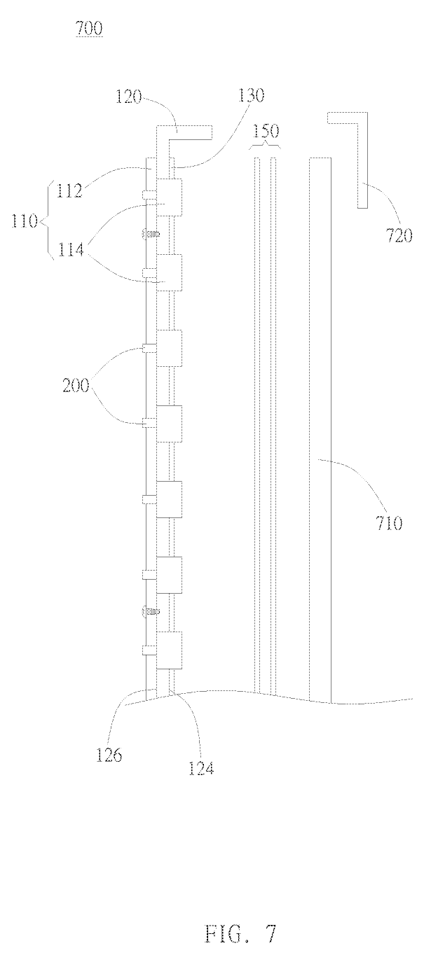

FIG. 6 and FIG. 7 illustrate an exploded view and a side view of a flat panel display device according to the present invention. The present invention further provides a display device 700 including a front frame 720 and a backlight module 100. In the embodiment shown in FIG. 6, the display device 700 further includes a liquid crystal panel 710 for receiving image signals to form images. The liquid crystal panel 710 is disposed between the optical films 150 and the front frame 720, and then assembled with the backlight module 100. In the present embodiment, the backlight module 100 is preferably adopted as a direct type LED backlight technology. The light source module 110 of the backlight module 100 can be directly provided with the heat dissipation unit, such as heat sink, radiating tube, etc., to solve the heat dissipation problems. For the structures of the backlight module 100, please refer to the aforesaid embodiment, they will not be repeated again here.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

We claim:

1. A backlight module, comprising:
a housing having an inner side surface, an outer side surface, and a plurality of first openings;
a reflective sheet disposed on the inner side surface, the reflective sheet having a plurality of second openings corresponding to the first openings; and
a light source module having a plurality of light sources, wherein the light source module is disposed on the outer side surface, the light sources penetrate the first openings and the second openings.

2. The backlight module of claim 1, wherein the housing further includes a back wall, and the inner side surface and the outer side surface respectively form opposite two surfaces of the back wall.

3. The backlight module of claim 1, further comprising of a plurality of optical films disposed parallel to the reflective sheet.

4. The backlight module of claim 1, wherein each of the light sources penetrates each of the first openings and the second openings.

5. The backlight module of claim 4, wherein a cross-section of each of the light source along a direction parallel to the housing corresponds to a shape of each of the first openings.

6. The backlight module of claim 1, wherein the light source module is composed of a printed circuit board with the light sources disposed thereon, the printed circuit board is disposed outside the outer side surface of the housing.

7. The backlight module of claim 6, wherein an upper surface of the printed circuit board is unexposed in the first openings.

8. The backlight module of claim 1, further comprising a heat dissipation unit disposed on the other side of the light source module opposite to the light sources.

9. The backlight module of claim 8, wherein the heat dissipation unit includes a heat sink, a heat pipe, or a heat dissipation post.

10. The backlight module of claim 1, wherein the light source module includes a light emitting diode module, and the light sources include a plurality of light emitting diode light sources.

11. A display device, comprising:
a liquid crystal display panel;
a front frame; and
a backlight module disposed in the front frame and under the liquid crystal display panel, the backlight module including:
a housing having an inner side surface, an outer side surface, and a plurality of first openings;
a reflective sheet disposed on the inner side surface, the reflective sheet having a plurality of second openings corresponding to the first openings; and
a light source module having a plurality of light sources, wherein the light source module is disposed on the outer side surface, and the light sources penetrate the first openings and the second openings;
wherein the front frame and the housing enclose the backlight module, the reflective sheet, and the liquid crystal display panel therein.

12. The display device of claim 11, wherein the housing further includes a back wall, and the inner side surface and the outer side surface respectively form two opposite sides of the back wall.

13. The display device of claim 11, further comprising a plurality of optical films disposed between the reflective sheet and the liquid crystal display panel and parallel to the reflective sheet.

14. The display device of claim 11, wherein each of the light sources penetrates each of the first openings and the second openings.

15. The display device of claim 14, wherein a cross-section of each of the light source along a direction parallel to the housing corresponds to a shape of each of the first openings.

16. The display device of claim 11, wherein the light source module is composed of a printed circuit board with the light sources disposed thereon, the printed circuit board is disposed outside the outer side surface of the housing.

17. The display device of claim 16, wherein an upper surface of the printed circuit board is unexposed in the first openings.

18. The display device of claim 11, further comprising a heat dissipation unit disposed on the other side of the light source module opposite to the light sources.

19. The display device of claim 18, wherein the heat dissipation unit includes a heat sink, a heat pipe, or a heat dissipation post.

20. The display device of claim 11, wherein the light source module includes a light emitting diode module, and the light sources include a plurality of light emitting diode light sources.
